(19) United States
(12) Patent Application Publication
(10) Pub. No.: US 2016/0202442 A1
(43) Pub. Date: Jul. 14, 2016

(54) ASSEMBLY STRUCTURE FOR BARREL AND LENS HOLDER

(71) Applicant: Hung-Yu HSIEH, Miaoli (TW)

(72) Inventor: Hung-Yu HSIEH, Miaoli (TW)

(21) Appl. No.: 14/593,170

(22) Filed: Jan. 9, 2015

(51) Int. Cl. G02B 7/02

(52) U.S. Cl. CPC G02B 7/02

(57) ABSTRACT

The present disclosure provides a barrel and a lens holder, wherein the barrel having a circular barrel wall and at least a protruding block, with the protruding block protruding beyond the circular barrel wall; the lens holder having a circular hollow wall and at least a spiral guiding track, inside of the circular hollow wall forming a housing space, the housing space having an entrance for placing the barrel; the spiral guiding track being formed axially on a ring-shaped diameter-oriented end surface at the entrance; the barrel being disposed inside the housing space axially and the protruding block maintaining contact with the spiral guiding track; when the barrel rotating, the protruding block sliding along the spiral guiding track so as to adjust the axial position of the barrel with respect to the lens holder.

### TECHNICAL FIELD

The technical field generally concerns optical lens technology, and in particular, assembly structures for barrel and lens holder applicable to small electronic products, for easy manufacturing.

### BACKGROUND

Portable electronic devices are constantly decreasing in size, evident in tablets, smartphones, and others. These portable devices often require photo taking optical lens with the structure of the barrel and lens holder inside the optical lens shown in FIG. 1. As shown in FIG. 1, the outer surface of a barrel 1 includes the outer screw thread 11 and the inner hole surface of a lens holder 2 includes inner screw thread 21. Both barrel 1 and the lens holder 2 use the screw thread structure for assembly and focus adjustment. The barrel 1 and the lens holder 2 are both manufactured by injection molding to form prototype. Afterwards, the screw threads are formed by a hinge tooth device. As the portable devices become thinner and smaller, the miniaturization of the barrel and the lens holder also demands higher precision. The known technique of injection molding followed by rotation of a hinge tooth device is prone to precision issues and is not suitable for high-end products.

### SUMMARY

The primary objective of the present invention is to provide an assembly structure for barrel and lens holder without screw thread, and capable of axial adjustment after assembly.

To achieve the above objective, the present disclosure provides a barrel and a lens holder, wherein the barrel having a circular barrel wall and at least a protruding block, with the protruding block protruding beyond the circular barrel wall; the lens holder having a circular hollow wall and at least a spiral guiding track, inside of the circular hollow wall forming a housing space, the housing space having an entrance for placing the barrel; the spiral guiding track being formed axially on a ring-shaped diameter-oriented end surface at the entrance; the barrel being disposed inside the housing space axially and the protruding block maintaining contact with the spiral guiding track; when the barrel rotating, the protruding block sliding along the spiral guiding track so as to adjust the axial position of the barrel with respect to the lens holder.

Another embodiment describes a barrel and a lens holder, wherein the barrel having a circular barrel wall and at least a protruding block, with the protruding block protruding beyond the circular barrel wall; the lens holder having a circular hollow wall and at least a spiral guiding track, inside of the circular hollow wall forming a housing space, the housing space having an entrance for placing the barrel; the spiral guiding track disposed along diameter orientation and pinching into the circular hollow wall, located at the entrance of the circular hollow wall, and the areas on the inner surface of the circular hollow wall covered by the spiral guiding track in axial orientation not overlapping; the barrel being disposed inside the housing space axially and the protruding block maintaining contact with the spiral guiding track; when the barrel rotating, the protruding block sliding along the spiral guiding track so as to adjust the axial position of the barrel with respect to the lens holder.

Yet another embodiment describes a barrel and a lens holder, wherein the barrel having a circular barrel wall and at least a spiral guiding track, with the spiral guiding track protruding beyond the circular barrel wall along the diameter orientation, and the areas on the outer surface of the circular barrel wall covered by the spiral guiding track in axial orientation not overlapping; the lens holder having a circular hollow wall and at least a protruding block, inside of the circular hollow wall forming a housing space, the housing space having an entrance for placing the barrel; the protruding block being located at the diameter-oriented end surface at the entrance of the lens holder, and protruding beyond the diameter-oriented end surface axially; the barrel being disposed inside the housing space axially and the protruding block maintaining contact with the spiral guiding track; when the barrel rotating, the spiral guiding track sliding to change the contact position with the protruding block so as to adjust the position of the barrel with respect to the lens holder.

The feature of the present disclosure is to use either the barrel or the lens holder to include a protruding block and the other to include a spiral guiding track. After assembly, the protruding block and the spiral guiding track maintain contact and can slide into each other. By rotating the barrel to adjust the axial position of the lens holder, the embodiments are all designed with the above basis. As shown in FIGS. 9A, 9B and 9C, different depositions of the protruding block and the spiral guiding track are shown.

In the present disclosure, the protruding block and the spiral guiding track may have the same number. In assembly structure, each protruding block contacts a corresponding spiral guiding track. When a plurality of protruding blocks is used, the number of the spiral guiding tracks must be smaller than or equal to the number of the protruding blocks.

In the present disclosure, when the barrel adjusts the axial position of the lens holder, the protruding block and the spiral guiding track must maintain contact. The contact may be a point contact, a linear contact, or a planar contact. Hence, the protruding block may have the shape of a protruding bump, a round pillar, a rectangular block or any other shape. The surface on guiding track along the diameter orientation may be a flat surface, curvy surface, slant surface or others.

The foregoing will become better understood from a careful reading of a detailed description provided herein below with appropriate reference to the accompanying drawings.

### BRIEF DESCRIPTION OF THE DRAWINGS

The embodiments can be understood in more detail by reading the subsequent detailed description in conjunction with the examples and references made to the accompanying drawings, wherein:

FIG. 1 shows a schematic view of a conventional barrel and lens holder;

FIG. 2 shows a schematic view of a first embodiment of the barrel and the lens holder in accordance with an embodiment;

FIG. 3A shows a schematic view of an embodiment of the barrel in FIG. 2;

FIG. 3B shows a schematic view of anther embodiment of the barrel in FIG. 2;

FIG. 4 shows a schematic view of a second embodiment of the barrel and the lens holder in accordance with an embodiment;

FIG. 5 shows a schematic view of a third embodiment of the barrel and the lens holder in accordance with an embodiment;

FIG. 6 shows a schematic view of a fourth embodiment of the barrel and the lens holder in accordance with an embodiment;

FIG. 7 shows a schematic view of a fifth embodiment of the barrel and the lens holder in accordance with an embodiment;

FIG. 8 shows a schematic view of a sixth embodiment of the barrel and the lens holder in accordance with an embodiment;

FIG. 9A shows a schematic view of the structure of the protruding block and the spiral guiding track in the first embodiment;

FIG. 9B shows a schematic view of the structure of the protruding block and the spiral guiding track in the third embodiment; and

FIG. 9C shows a schematic view of the structure of the protruding block and the spiral guiding track in the fifth embodiment.

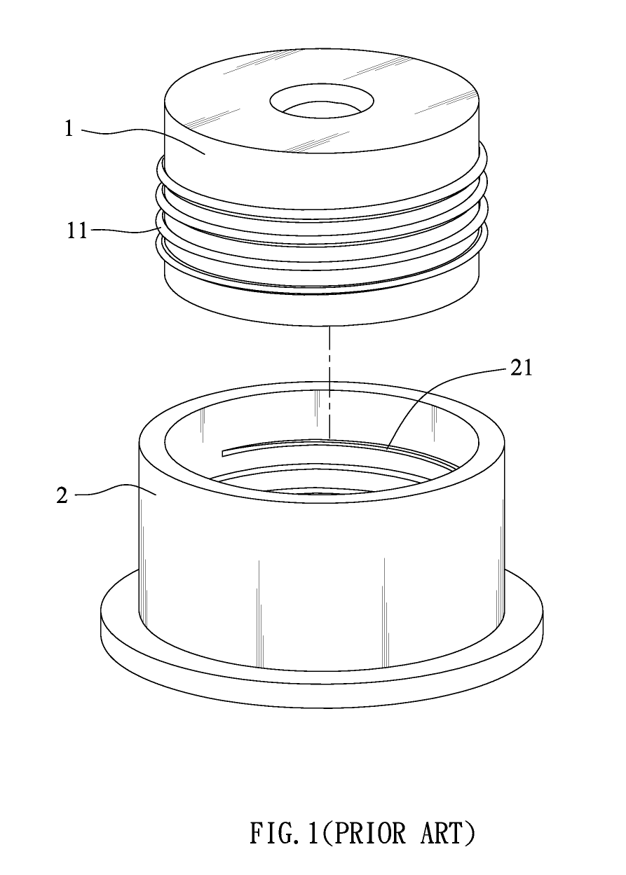

### DETAILED DESCRIPTION OF THE DISCLOSED EMBODIMENTS

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

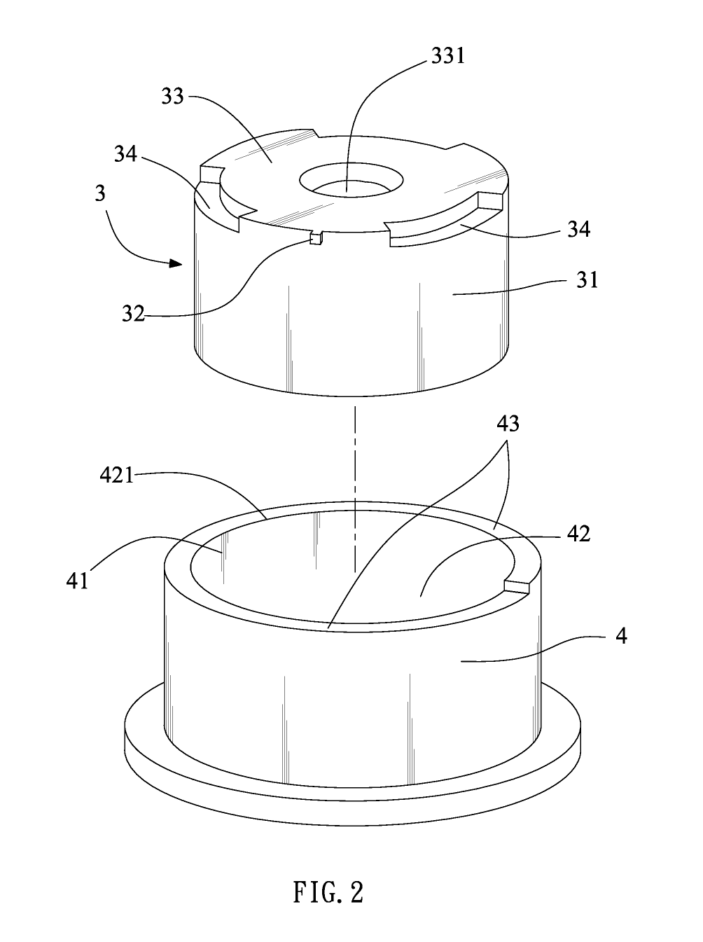

FIG. 2 shows a schematic view of a first embodiment of the barrel and the lens holder in accordance with an embodiment. The barrel 3 has a circular barrel wall 31 and at least a protruding block 32, with the protruding block 32 protruding beyond the circular barrel wall 31. The barrel 3 has a hole 331 at the barrel top surface 33, with at least a lens disposed inside. The hole 331 is for allowing light to enter the barrel 3, which is similar to known technique and will not be described in details. The protruding block 32 is located near the barrel top surface 33. A plurality of stuck trenches 34 is formed at the circumference of the conjunction between the barrel top surface 33 and the circular barrel wall 31 for the convenience of using tool to stick inside the trench to rotate the barrel 3 when adjusting.

The lens holder 4 has a circular hollow wall 41 and at least a spiral guiding track 43. The inside of the circular hollow wall 41 forms a housing space 42, the housing space has an entrance 421 for placing the barrel 3 into the housing space 42. The spiral guiding track 43 is formed axially on a ring-shaped diameter-oriented end surface at the entrance 421 of the lens holder 4. In other words, the horizontal position of the spiral guiding track 43 gradually decreases with the axial direction. As such, the barrel 3 and the lens holder 4 do not include any screw threads, and both can be manufactured by injection molding without additional process. Therefore, the precision of the barrel 3 and the lens holder 4 can be effectively controlled.

For assembly of the instant embodiment, the barrel 3 is placed into the housing space 42 through the entrance 421 along the axial direction. Then, the protruding block 32 maintains contact with the spiral guiding track 43 so that the barrel 3 is temporarily unable to move inside the lens holder 4 along the axial direction. However, before fixing the components of this type of optical lens, a focus fine-tuning must be performed. At this point, a tool may be used to rotate the barrel 3 so that the protruding block 32 slides along the spiral guiding track to adjust the axial position of the barrel 3 with respect to the lens holder 4 to achieve the fine-tuning. After adjustment, the glue is applied to fix the barrel 3 to the lens holder 4.

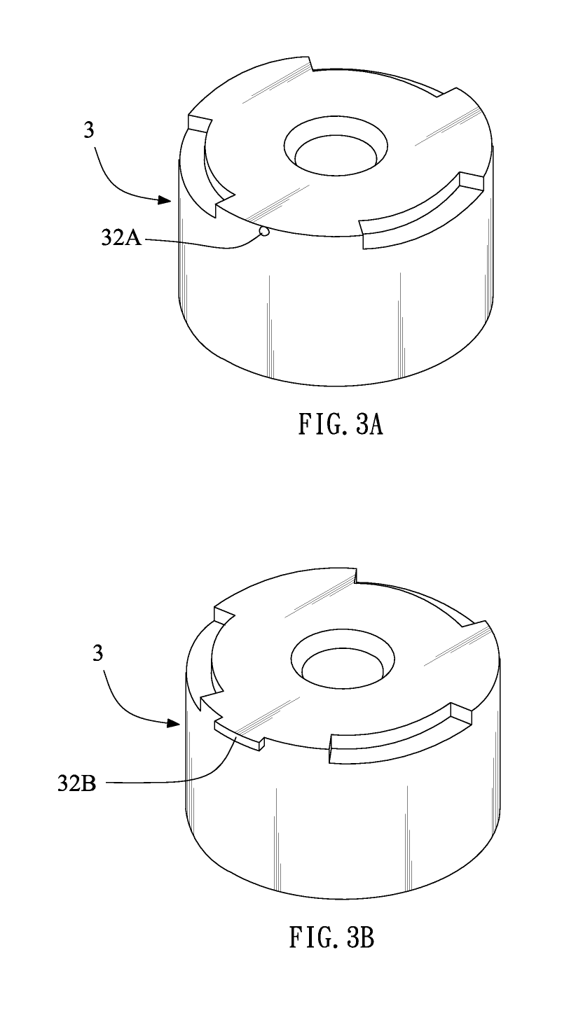

The present disclosure uses the protruding block 32 against the spiral guiding track 43 and makes these two maintain contact. As such, by rotating the barrel 3, the adjustment of the relative position between the barrel 3 and the lens 4 is accomplished. The contact between the protruding block 32 and the spiral guiding track 43 may be at least one of a point contact, a linear contact, or a planar contact. Hence, the protruding block and the spiral guiding track 43 may have various shapes. The following describes some embodiment for illustrative, instead of restrictive, purpose. As shown in FIG. 2, the protruding block 32 is a rectangular body, and the diameter-orientation surface of the spiral guiding track has a flat surface. As shown in FIG. 3A, the protruding block 32A has a shaped of hemispherical bump. As shown in FIG. 3B, the protruding block 32B is a long stripe guiding block with a spiral shape matching that of the spiral guiding track 43. In addition, the protruding block can also have a shape of a round pillar or any other shape. The surface on spiral guiding track along the diameter-orientation may be curvy, slant surface or others.

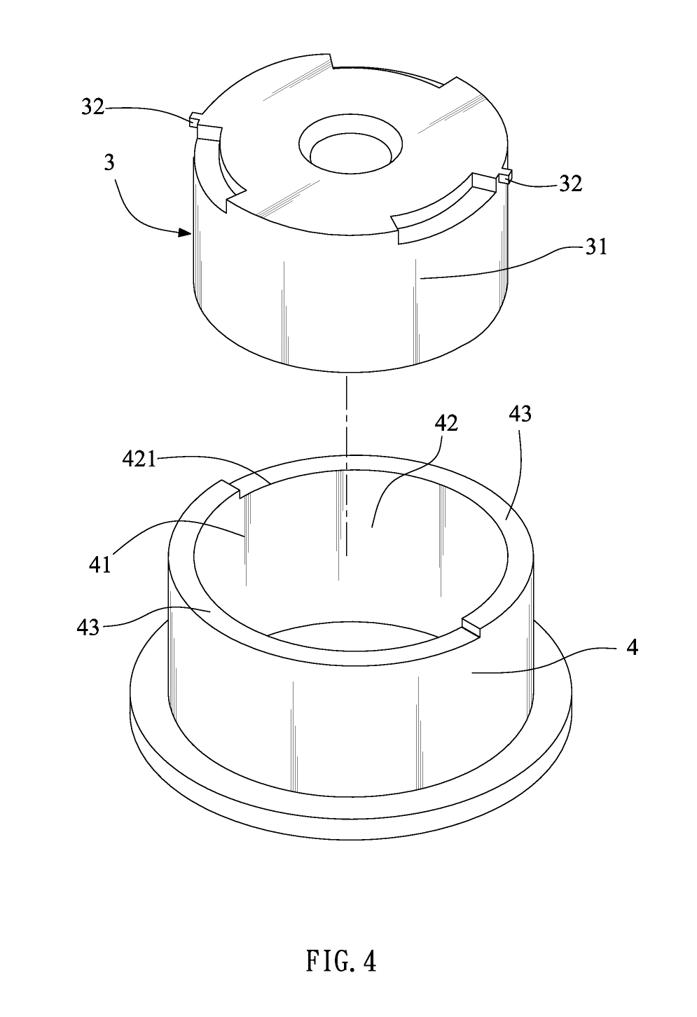

In the embodiment, the number of protruding blocks 32 of the barrel 3 is the same of the number of the spiral guiding track 43 of the lens holder 4. As shown in FIG. 2, there is one protruding block 32 and one spiral guiding track 43. However, as shown in FIG. 4, the barrel 3 includes two protruding blocks 32 and correspondingly the lens holder 4 also includes two spiral guiding tracks 43. In a preferred embodiment, the protruding blocks 32 are uniformly distributed on the circular barrel wall 31 at equal interval, and the spiral guiding tracks are also uniformly distributed around the ring-shape diameter-orientation end surface of the lens holder 4, and the number of the spiral guiding tracks is equal to the number of the protruding blocks. However, if the number of protruding blocks is plural, the number of the spiral guiding tracks must be smaller than or equal to the number of the protruding blocks.

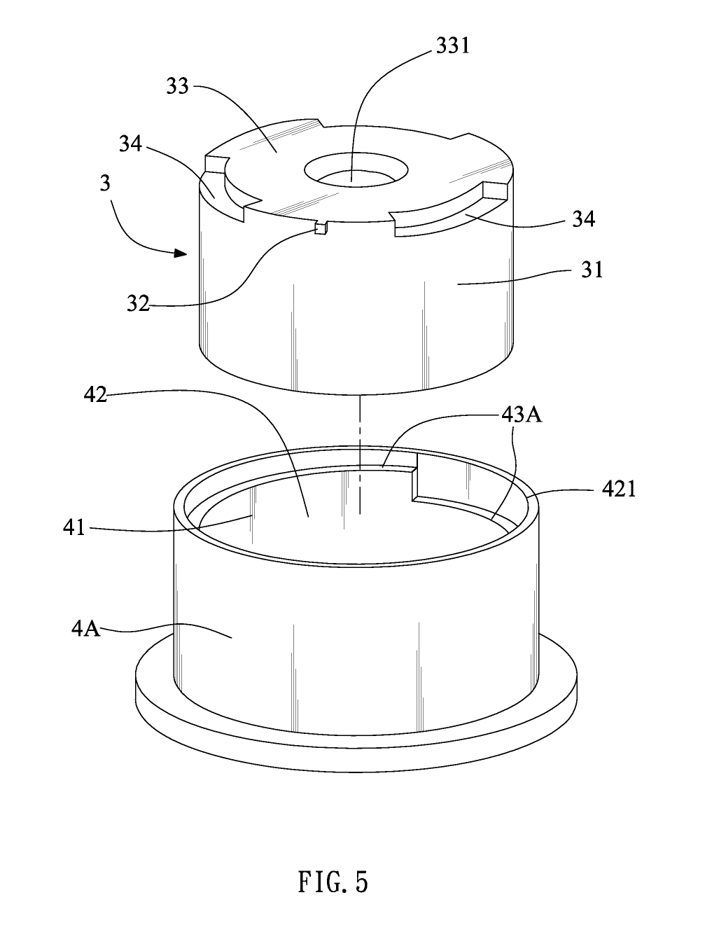

FIG. 5 shows a schematic view of a third embodiment of the barrel and the lens holder in accordance with an embodiment. In the instant embodiment, the barrel 3 has the same shape as in the embodiment of FIG. 2. However, the lens holder 4A is different, with the difference lies in changing the location of the spiral guiding track 43A. In the instant embodiment, the spiral guiding track 43A pinches into the circular hollow wall 41 in the diameter orientation and is located at the entrance 421 of the circular hollow wall 41. The areas on the inner surface of the circular hollow wall 41 covered by the spiral guiding track 43A in axial orientation will not overlap. As shown in the figure, the areas on the inner surface of the circular hollow wall 41 covered by the spiral guiding track 43A in axial orientation equals to the circumference, and therefore, the length of the spiral guiding track 43A will be longer than a circumference of the circular hollow wall 41. However, it is not restricted by this embodiment. The spiral guiding track 43A can also be formed partially on the circular hollow wall 41. The length design depends on the adjustment distance along the axial direction.

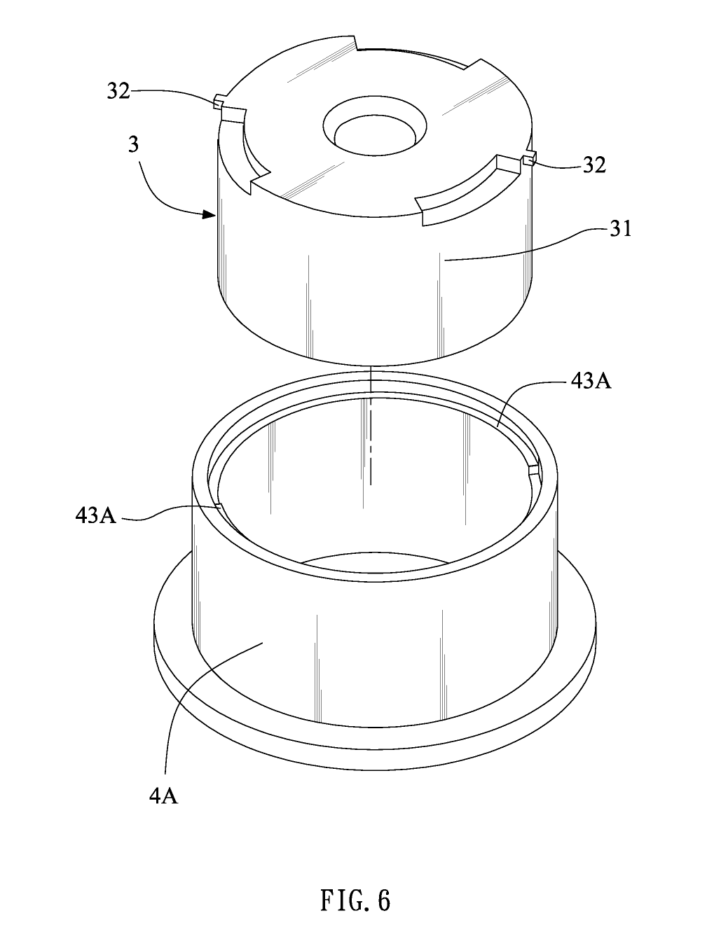

FIG. 6 shows a schematic view of a fourth embodiment of the barrel and the lens holder in accordance with an embodiment. The instant embodiment is an enhancement on the embodiment of FIG. 5. In the instant embodiment, the barrel 3 includes two protruding blocks 32, and the lens holder 4 also includes two spiral guiding tracks 43A correspondingly. In a preferred embodiment, the protruding blocks 32 are uniformly distributed on the circular barrel wall 31 at equal interval, and the spiral guiding tracks 43A are also uniformly distributed around the ring-shape diameter-orientation end surface of the lens holder 4. However, the above is not restrictive.

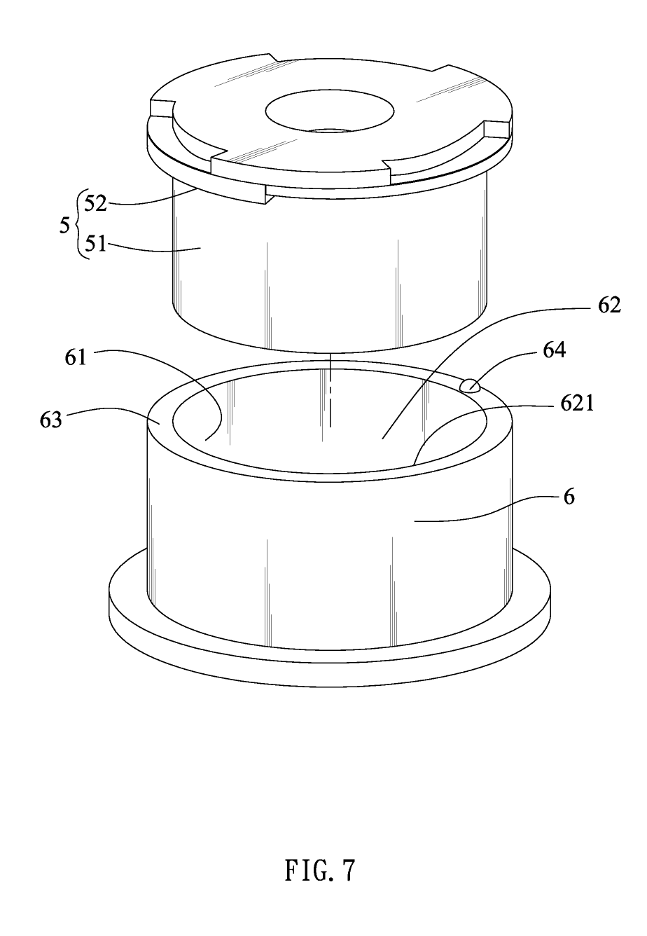

FIG. 7 shows a schematic view of a fifth embodiment of the barrel and the lens holder in accordance with an embodiment. The instant embodiment includes a barrel 5 and a lens holder 6, with different structures. The barrel 5 has a circular barrel wall 51 and at least a spiral guiding track 52, with the spiral guiding track 52 protruding beyond the circular barrel wall 51 along the diameter orientation. The areas on the outer surface of the circular barrel wall 51 covered by the spiral guiding track 52 in axial orientation do not overlap. The lens holder 6 has a circular hollow wall 61 and at least a protruding block 64, with inside of the circular hollow wall 61 forming a housing space 62. The housing space 62 has an entrance 621 for placing the barrel 5. The protruding block 64 is located at the diameter-oriented end surface 63 at the entrance 621 of the lens holder 6, and protruding beyond the diameter-oriented end surface 63 axially. In the instant embodiment, the barrel 5 and the lens holder 6 can be manufactured by injection molding without additional process. Also, the maximum distance of the spiral guiding track 52 is the axial vertical distance between the head and the tail of the spiral guiding track 52, and the maximum distance must be less than the vertical distance of the protruding block 64 protruding beyond the diameter-orientation end surface 63 to avoid interference. The shapes of the spiral guiding track 52 and the protruding block 64 are not restricted to any specific shapes, as described in previous embodiments.

For assembly of the instant embodiment, the barrel 5 is placed into the housing space 62 through the entrance 621 along the axial direction. Then, the protruding block 64 maintains contact with the spiral guiding track 52 so that the barrel 5 is temporarily unable to move inside the lens holder 6 along the axial direction. However, before fixing the components of this type of optical lens, a focus fine-tuning must be performed. At this point, a tool may be used to rotate the barrel 5 so that the spiral guiding track 52 slides along the spiral guiding track to change the contact position with the protruding block 64 so as to adjust the axial position of the barrel 5 with respect to the lens holder 6. After adjustment, the glue is applied to fix the barrel 5 to the lens holder 6.

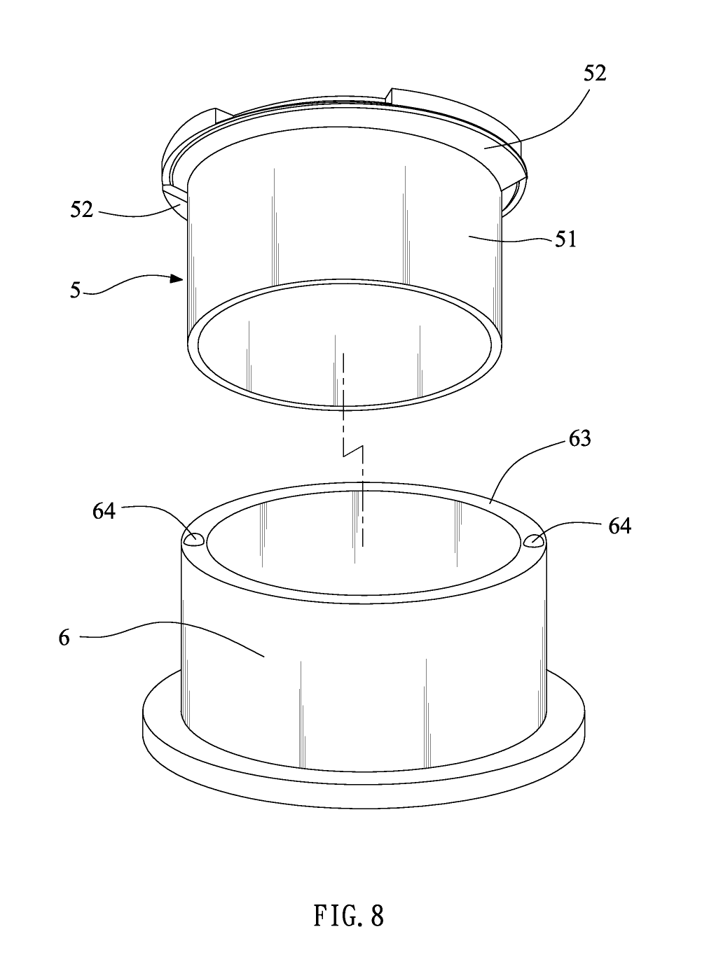

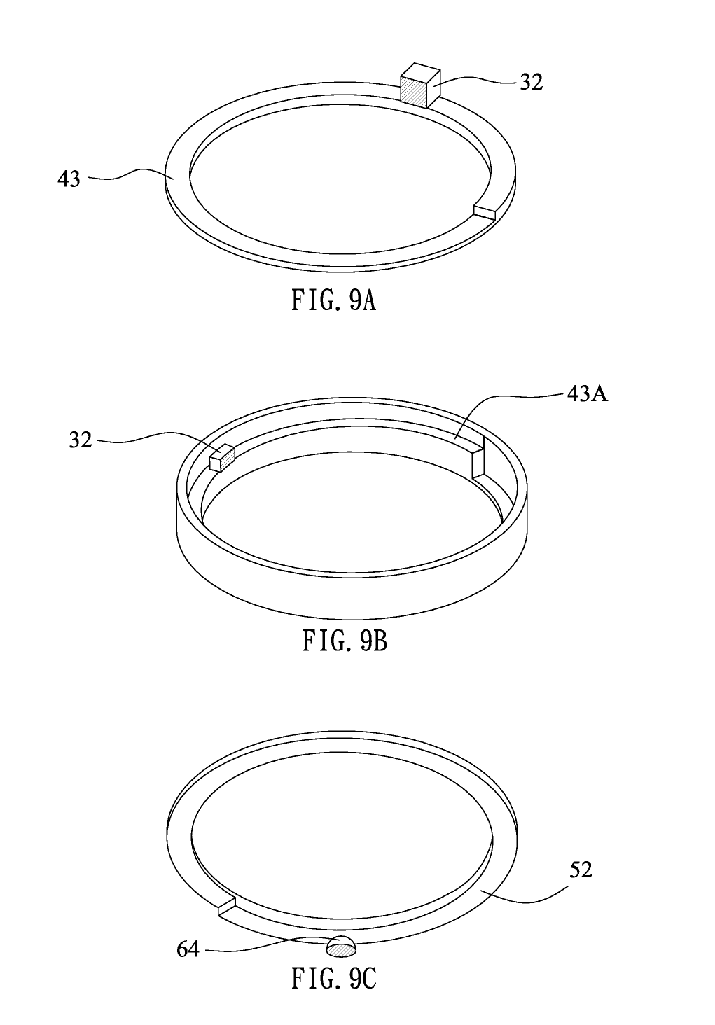

In the embodiment of FIG. 7, the number of the protruding block 64 is one and the number of the spiral guiding track 52 is also one. In comparison, FIG. 8 shows a schematic view of a sixth embodiment of the barrel and the lens holder in accordance with an embodiment. In the instant embodiment, the lens holder 6 includes two protruding blocks 64, and the barrel 5 also includes two spiral guiding tracks 52 correspondingly. In a preferred embodiment, the protruding blocks 64 are uniformly distributed on the diameter-orientation end surface 63 at equal interval, and the spiral guiding tracks 52 are also uniformly distributed around the circular barrel wall 51. However, the above is not restrictive.

In summary, the present disclosure provides a barrel and a lens holder without the screw thread so that the injection molding can be used in manufacturing without any additional process to accomplish high precision as well as stable quality. The present disclosure is applicable to optical lens for smartphones.

Various modifications and variations can be made to the disclosed embodiments. It is intended that the specification and examples be considered as exemplary only, with a true scope of the disclosure being indicated by the following claims and their equivalents.

What is claimed is:

1. An assembly structure for barrel and lens holder, comprising: a barrel and a lens holder;
wherein the barrel having a circular barrel wall and at least a protruding block, with the protruding block protruding beyond the circular barrel wall;
the lens holder having a circular hollow wall and at least a spiral guiding track, inside of the circular hollow wall forming a housing space, the housing space having an entrance for placing the barrel; the spiral guiding track being formed axially on a ring-shaped diameter-oriented end surface at the entrance; and
the barrel being disposed inside the housing space axially and the protruding block maintaining contact with the spiral guiding track; when the barrel rotating, the protruding block sliding along the spiral guiding track so as to adjust the axial position of the barrel with respect to the lens holder.

2. The assembly structure as claimed in claim 1, wherein the number of the protruding blocks is greater than one.

3. The assembly structure as claimed in claim 2, wherein the number of the protruding blocks is greater than one, and the number of the spiral guiding tracks is smaller than or equal to the number of the protruding blocks.

4. An assembly structure for barrel and lens holder, comprising: a barrel and a lens holder;
wherein the barrel having a circular barrel wall and at least a protruding block, with the protruding block protruding beyond the circular barrel wall;
the lens holder having a circular hollow wall and at least a spiral guiding track, inside of the circular hollow wall forming a housing space, the housing space having an entrance for placing the barrel; the spiral guiding track disposed along diameter orientation and pinching into the circular hollow wall, located at the entrance of the circular hollow wall, and the areas on the inner surface of the circular hollow wall covered by the spiral guiding track in axial orientation not overlapping; and
the barrel being disposed inside the housing space axially and the protruding block maintaining contact with the spiral guiding track; when the barrel rotating, the protruding block sliding along the spiral guiding track so as to adjust the axial position of the barrel with respect to the lens holder.

5. The assembly structure as claimed in claim 4, wherein the number of the protruding blocks is greater than one.

6. The assembly structure as claimed in claim 5, wherein the number of the protruding blocks is greater than one, and the number of the spiral guiding tracks is smaller than or equal to the number of the protruding blocks.

7. An assembly structure for barrel and lens holder, comprising: a barrel and a lens holder;
wherein the barrel having a circular barrel wall and at least a spiral guiding track, with the spiral guiding track protruding beyond the circular barrel wall along the diameter orientation, and the areas on the outer surface of the circular barrel wall covered by the spiral guiding track in axial orientation not overlapping;
the lens holder having a circular hollow wall and at least a protruding block, inside of the circular hollow wall forming a housing space, the housing space having an entrance for placing the barrel; the protruding block being located at the diameter-oriented end surface at the entrance of the lens holder, and protruding beyond the diameter-oriented end surface axially; and
the barrel being disposed inside the housing space axially and the protruding block maintaining contact with the spiral guiding track; when the barrel rotating, the spiral guiding track sliding to change the contact position with the protruding block so as to adjust the position of the barrel with respect to the lens holder.

8. The assembly structure as claimed in claim 7, wherein the maximum distance of the spiral guiding track is the axial vertical distance between the head and the tail of the spiral guiding track, and the maximum distance must be less than the vertical distance of the protruding block protruding beyond the diameter-orientation end surface to avoid interference

9. The assembly structure as claimed in claim 7, wherein the number of the protruding blocks is greater than one.

10. The assembly structure as claimed in claim 9, wherein the number of the protruding blocks is greater than one, and the number of the spiral guiding tracks is smaller than or equal to the number of the protruding blocks.
